(19) United States
(12) Patent Application Publication
(10) Pub. No.: US 2025/0280999 A1
(43) Pub. Date: Sep. 11, 2025

(54) ON-LINE BEVERAGE BLENDING MECHANISM

(71) Applicant: Dongguan ZEEWAY-Technology Ltd, Guangdong Province (CN)

(72) Inventors: Mengyi Zhu, Guangdong Province (CN); Liang Zhou, Guangdong Province (CN)

(73) Assignee: Dongguan ZEEWAY-Technology Ltd, Guangdong Province (CN)

(21) Appl. No.: 18/988,852

(22) Filed: Dec. 19, 2024

(30) Foreign Application Priority Data
Mar. 7, 2024 (CN) 2024204415489

(51) Int. Cl. A47J 43/08; A47J 31/44

(52) U.S. Cl. CPC A47J 43/085; A47J 31/4403

(57) ABSTRACT

The present disclosure discloses an on-line beverage blending mechanism, installed on a bubble tea machine, comprising a mounting seat, a load cell, a base and a shaker cup, wherein the mounting seat is provided on the bubble tea machine, the load cell is installed on the mounting seat at one end and on bottom of the base at the other end, and the shaker cup is installed on the base. The on-line beverage blending mechanism is installed onto the bubble tea machine by providing the load cell therebetween, so as to realize accurate weighing of the on-line beverage blending mechanism. Raw materials for a bubble tea can be directly poured into the on-line beverage blending mechanism for weighing, without using a measuring cup and no need of cleaning the measuring cup. Hence efficiency of preparation of the bubble tea is improved, and the on-line beverage blending mechanism can be provided in manner of a cantilever, so that wiping desktop of the bubble tea machine is not influenced, avoiding existence of an area can't be cleaned, and ensuring the bubble tea machine to be clean and sanitary.

### TECHNICAL FIELD

The present disclosure relates to technical field of shaker machines, and especially to an on-line beverage blending mechanism.

### BACKGROUND

With development of automation technology, automation technology is widely used in all aspects of social life, greatly improving people's labor productivity. However, application of automation technology in beverage service industry is relatively difficult. Especially in production process of on-site production and sale of beverages (e.g., bubble tea, cocktails, and other mixed beverages), an operator is required to pour raw materials into a measuring cup, and then pour the raw materials in the measuring cup into a shaker cup, and mix them by manually shaking the shaker cup. There exist not only problems in high labor intensity and low productivity, but also a problem of cleaning of the measuring cup after each use which is necessary, a problem of accurately measuring the raw materials which is impossible, and so on.

### SUMMARY

Main purpose of the present disclosure is to provide an on-line beverage blending mechanism, on which a load cell is provided, to solve above technical problems.

In order to realize the above purpose, the present disclosure adopts the following technical solutions:

An on-line beverage blending mechanism, for being installed on a bubble tea machine, comprising a mounting seat, a load cell, a base and a shaker cup, wherein the mounting seat is provided on the bubble tea machine, the load cell is installed on the mounting seat at one end and on bottom of the base at the other end, and the shaker cup is installed on the base.

As a preferred technical solution, the base is to receive a motor together with a mounting plate and a connecting member, wherein the mounting plate is installed on the top of the base, the motor is to be fixed on the mounting plate and placed in the base, and the connecting member is used to be installed on an output end of the motor.

As a preferred technical solution, the connecting member is provided with a connecting groove, and the shaker cup is provided with a connecting block at the lower end, and the shape of the connecting block matches that of the connecting groove.

As a preferred technical solution, it is further provided with a water-blocking plate, wherein the water-blocking plate is used to be installed on the bubble tea machine and located above the load cell.

As a preferred technical solution, the base is provided with a waterproof block, wherein the waterproof block is raised at one end, and the waterproof block is located between the water blocking plate and the load cell.

Beneficial effects of the present disclosure lie in that: the above on-line beverage blending mechanism is installed onto a bubble tea machine by providing a load cell therebetween, so as to realize accurate weighing of the on-line beverage blending mechanism. Raw materials for a bubble tea can be directly poured into the on-line beverage blending mechanism for weighing, without using a measuring cup for measuring and without need of cleaning the measuring cup. Hence efficiency of preparation of the bubble tea is improved, and at the same time, the on-line beverage blending mechanism can be provided in manner of a cantilever, so that wiping desktop of the bubble tea machine is not influenced, avoiding existence of an area can't be cleaned, and ensuring the bubble tea machine to be clean and sanitary.

### BRIEF DESCRIPTION OF FIGURES

FIG. 1 shows a schematic view of an on-line beverage blending mechanism involved in the present disclosure, which is installed on a bubble tea machine;

FIG. 2 shows a sectional view of the on-line beverage blending mechanism involved in the present disclosure;

FIG. 3 shows a partially enlarged view at b in FIG. 2.

### DETAILED DESCRIPTION

In order to more clearly explain purpose, technical solution and advantages of the present disclosure, the present disclosure is described in detail hereinafter in conjunction with accompanying drawings and embodiments. It should be understood that specific embodiments described here are intended only to explain the present disclosure and not to limit the present disclosure.

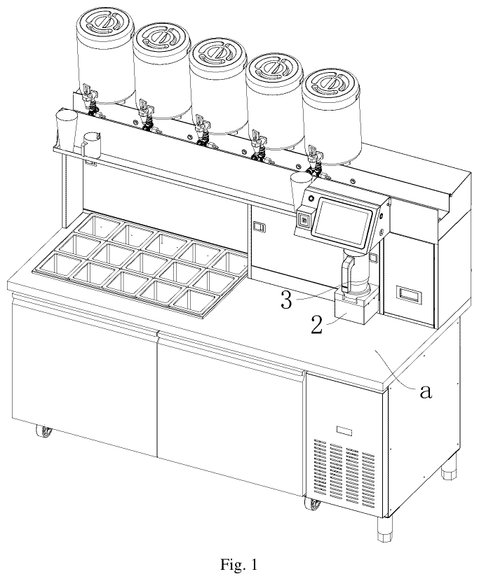

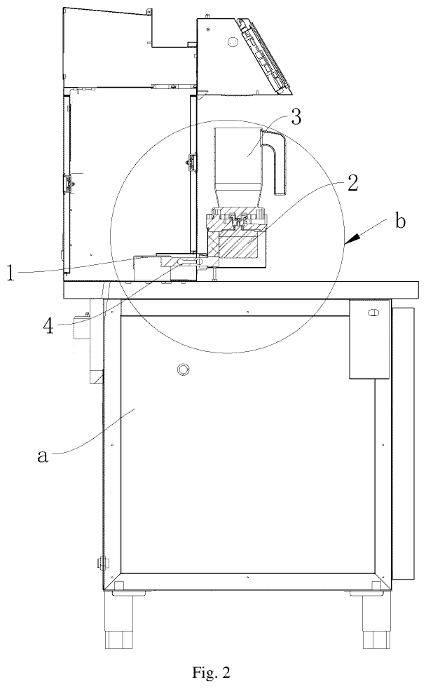

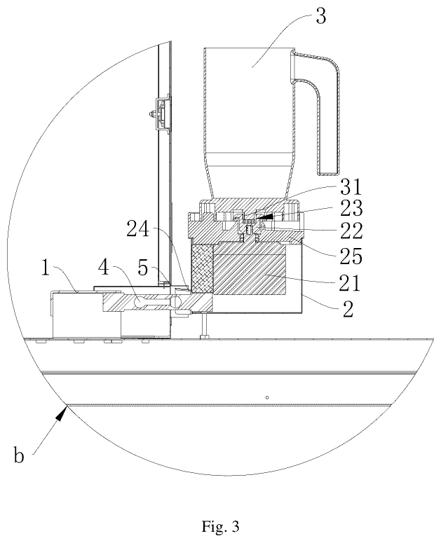

As shown in connection with FIG. 1-FIG. 3, an on-line beverage blending mechanism, for being installed on a bubble tea machine, comprises a mounting seat 1, a load cell 4, a base 2, a shaker cup 3, and a water-blocking plate 5. The mounting seat 1 and the water-blocking plate 5 are provided on the bubble tea machine a. The load cell 4 is installed on the mounting seat 1 at one end, and on bottom of the base 2 at the other end, so as to provide the base 2 in manner of a cantilever so that wiping the desktop of the bubble tea machine is not influenced, avoiding existence of an area difficult to be cleaned, and ensuring the bubble tea machine to be clean and sanitary. The shaker cup 3 is installed on the base 2. When raw materials for a bubble tea are placed into the shaker cup 3, the load cell 4 leads to a slight deformation, so as to determine weight of the raw materials in the shaker cup 3. The water-blocking plate 5 is installed on the bubble tea machine a, and is located above the load cell 4, so that liquid is prevented from being immersed in the load cell 4 to ensure accuracy of the load cell 4.

Specifically, the base 2 is to receive a motor 21 together with a mounting plate 25 and a connecting member 22, and a waterproof block 24. The mounting plate 25 is installed on top of the base 2. The motor 21 is fixed on the mounting plate 25 and is placed in the base 2 to protect the motor 21 from damage caused by liquid coming into and contacting with the motor 21. The connecting member 22 is installed at an output end of the motor 21. The connecting member 22 is provided with a connecting groove 23. A lower end of the shaker cup 3 is provided with a connecting block 31. The shape of the connecting block 31 matches that of the connecting groove 23 and the connecting block 31 is fixed to a stirrer built in the shaker cup 3, so that when the shaker cup 3 is installed on the base 2, the connecting block 31 is embedded in the connecting groove 23. Once the motor 21 is driven, the connecting member 22 is driven to rotate, which in turn drives the connecting block 31 to rotate, so as to drive the stirrer to rotate. The base 2 is provided with a waterproof block 24, which raises at one end and is located between the water blocking plate 5 and the load cell 4 to guide liquid to flow between the water-blocking plate 5 and the waterproof block 24, thereby realizing waterproofing.

The above mentioned embodiments are just the better examples of the present disclosure, and not intended to limit scope of the present disclosure. Any equivalent changes or modifications made in accordance with the structures, features and principles described in the scope of the present disclosure should be fallen in the scope of the present disclosure.

What is claimed is:

1. An on-line beverage blending mechanism, for being installed on a bubble tea machine, comprising a mounting seat, a load cell, a base and a shaker cup, wherein the mounting seat is provided on the bubble tea machine, the load cell is installed on the mounting seat at one end and on bottom of the base at the other end, and the shaker cup is installed on the base.

2. The on-line beverage blending mechanism of claim 1, wherein the base is to receive a motor together with a mounting plate and a connecting member, and wherein the mounting plate is installed on the top of the base, the motor is to be fixed on the mounting plate and placed in the base, and the connecting member is used to be installed on an output end of the motor.

3. The on-line beverage blending mechanism of claim 2, wherein the connecting member is provided with a connecting groove, the shaker cup is provided with a connecting block at the lower end, and the shape of the connecting block matches that of the connecting groove.

4. The on-line beverage blending mechanism of claim 3, further being provided with a water-blocking plate, wherein the water-blocking plate is used to be installed on the bubble tea machine and located above the load cell.

5. The on-line beverage blending mechanism of claim 4, wherein the base is provided with a waterproof block, wherein the waterproof block is raised at one end, and the waterproof block is located between the water blocking plate and the load cell.
